(19) United States
(12) Patent Application Publication
(10) Pub. No.: US 2023/0271138 A1
(43) Pub. Date: Aug. 31, 2023

(54) APPARATUS FOR PRODUCING ULTRAPURE WATER

(71) Applicant: ORGANO CORPORATION, Tokyo (JP)

(72) Inventors: Fumitaka ICHIHARA, Tokyo (JP); Fumio SUDO, Tokyo (JP); Tsukasa KONDO, Tokyo (JP); Hiroshi SUGAWARA, Tokyo (JP)

(73) Assignee: ORGANO CORPORATION, Tokyo (JP)

(21) Appl. No.: 18/015,436

(22) PCT Filed: Jun. 11, 2021
(86) PCT No.: PCT/JP2021/022283

§ 371 Date: Jan. 10, 2023

(30) Foreign Application Priority Data
Jul. 13, 2020 (JP) 2020-120092

(51) Int. Cl. B01D 61/22; C02F 1/00; C02F 1/44; B01D 61/14; B01D 61/18

(52) U.S. Cl. CPC B01D 61/22; C02F 1/008; C02F 1/444; B01D 61/146; B01D 61/18; C02F 2103/04

(57) ABSTRACT

An apparatus for producing ultrapure water: first ultrafiltration membrane that is connected to point of use and that supplies ultrapure water to point of use; first concentrated water return line that returns concentrated water of first ultrafiltration membrane to an upstream side of first ultrafiltration membrane; pressure gauge that measures pressure at an outlet of first ultrafiltration membrane; and means for adjusting flow rate of the concentrated water (first valve). Means for adjusting the flow rate of the concentrated water can be operated such that when the flow rate of the concentrated water is changed, a change in the pressure at the outlet of first ultrafiltration membrane that is measured by pressure gauge is kept within a predetermined range.

### FIELD OF THE INVENTION

The present application is based on and claims priority from JP2020-120092 filed on Jul. 13, 2020, the disclosure of which is hereby incorporated by reference herein in its entirety.

The present invention relates to an apparatus for producing ultrapure water, and particularly relates to the arrangement of a subsystem that produces ultrapure water from pure water.

### BACKGROUND OF THE INVENTION

In the manufacturing process of semiconductor devices and liquid crystal devices, ultrapure water from which impurities are removed to a high degree is used for various applications such as washing processes. Ultrapure water is typically produced by sequentially treating raw water (river water, underground water, industrial water, and the like) by a pretreatment system, a primary pure water system, and a secondary pure water system (subsystem). Since fine particles that are contained in ultrapure water directly cause decrease in the yield of devices, the size (particle diameter) and the number (concentration) are strictly managed. Thus, a subsystem having an ultrafiltration membrane at the final stage thereof is proposed in order to reduce the number of fine particles in ultrapure water (see WO 2017/145419).

Ultrafiltration membranes are typically operated not to allow all of the water to pass therethrough but to return a part of the concentrated water to the upstream side thereof. The flow rate of the concentrated water that is returned to the upstream side is determined depending on, for example, the requirements of water quality. However, it is desirable to reduce the flow rate of the concentrated water to the greatest extent possible so as to limit the water production cost. For this purpose, the flow rate of the concentrated water may be changed during the operation while monitoring the water quality. This process causes a change in the pressure of the water to be treated, particularly the pressure at the inlet and the outlet of the ultrafiltration membrane. It is known that fine particles that adhere to the inner wall of a pipe and the like may detach in this process due to the change in the pressure, as described in WO 2017/145419. According to the art described in WO 2017/145419, fine particles that adhere to the pipe are removed by supplying ultrapure water at a high pressure. In order to prevent the ultrafiltration membrane from being clogged during a high-pressure washing process, the ultrafiltration membrane is removed and a dummy pipe or a dummy membrane is provided that does not have the function of the ultrafiltration membrane.

### SUMMARY OF THE INVENTION

On the other hand, JP6670206 discloses that fine particles detach from an ultrafiltration membrane during the operation of an apparatus for producing ultrapure water and thereby affect the water quality of the ultrapure water. Therefore, the method disclosed in patent document 1 cannot prevent the ultrafiltration membrane from generating fine particles during operation. In addition, ultrapure water cannot be produced during a high-pressure washing process, and the process requires operations for attaching and removing the ultrafiltration membrane before and after the washing, and these operations decrease the operation rate of the apparatus for producing ultrapure water.

The present invention aims at providing an apparatus for producing ultrapure water that has a simple arrangement, that can reduce water production cost, and that can prevent an ultrafiltration membrane from generating fine particles during operation.

An apparatus for producing ultrapure water of the present invention comprises: a first ultrafiltration membrane that is connected to a point of use and that supplies ultrapure water to the point of use; a first concentrated water return line that returns concentrated water of the first ultrafiltration membrane to an upstream side of the first ultrafiltration membrane; a pressure gauge that measures pressure at an outlet of the first ultrafiltration membrane; and means for adjusting flow rate of the concentrated water, the means adjusting the flow rate of the concentrated water. The means for adjusting the flow rate of the concentrated water can be operated such that when the flow rate of the concentrated water is changed, a change in the pressure at the outlet of the first ultrafiltration membrane that is measured by the pressure gauge is kept within a predetermined range.

According to the present invention, it is possible to provide an apparatus for producing ultrapure water that has a simple arrangement, that can reduce water production cost, and that can prevent an ultrafiltration membrane from generating fine particles during operation.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a schematic view of the arrangement of an apparatus for producing ultrapure water according to a first embodiment of the present invention;

FIG. 2 is a schematic view of the arrangement of a subsystem of the apparatus for producing ultrapure water shown in FIG. 1;

FIG. 3 is a view schematically illustrating the temporal change in the pressure at the outlet of the first ultrafiltration membrane;

FIG. 4 is a schematic view of the arrangement of an apparatus for producing ultrapure water according to a second embodiment of the present invention;

FIG. 5 is a schematic view of the arrangement of an apparatus for producing ultrapure water according to a third embodiment of the present invention;

FIG. 6 is a schematic view of the arrangement of an apparatus for producing ultrapure water according to a fourth embodiment of the present invention;

FIG. 7 is a schematic view of the arrangement of an apparatus for producing ultrapure water according to a fifth embodiment of the present invention; and

FIG. 8 is a schematic view of the arrangement of an apparatus for producing ultrapure water according to a sixth embodiment of the present invention.

### DESCRIPTION OF EMBODIMENTS

### First Embodiment

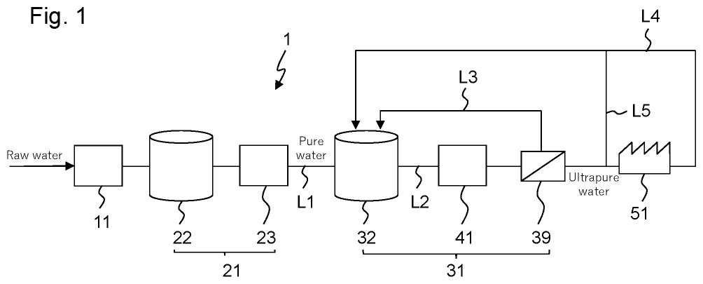

FIG. 1 schematically shows the arrangement of apparatus for producing ultrapure water 1 according to the first embodiment of the present invention. Apparatus for producing ultrapure water 1 includes pretreatment system 11 that treats raw water to produce primary treated water, primary pure water system 21 that produces pure water from the primary treated water that is produced by pretreatment system 11, and secondary pure water system 31 (hereinafter, referred to as subsystem 31) that produces ultrapure water from the pure water that is produced by primary pure water system 21. Primary pure water system 21 includes primary treated water tank 22 that stores the primary treated water and purifying unit 23 that consists of a reverse-osmosis membrane, an ultraviolet-ray oxidization apparatus, a microfiltration membrane, and so on (these components of purifying unit 23 not being shown), and supplies pure water to subtank 32 of subsystem 31 via pure water supply line L1.

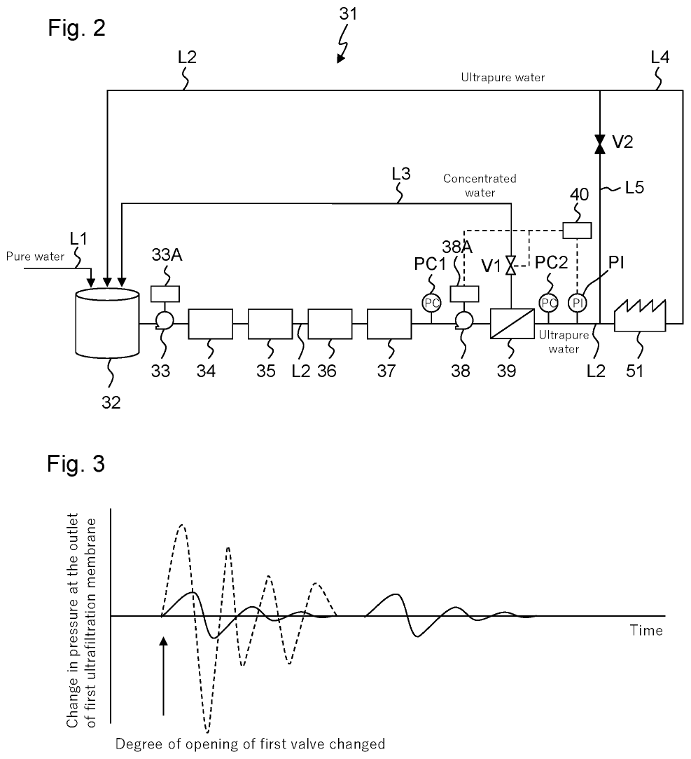

FIG. 2 schematically shows the arrangement of subsystem 31 shown in FIG. 1. Subsystem 31 includes subtank 32, first pump 33, ultraviolet-ray oxidization apparatus 34, hydrogen peroxide removal apparatus 35, ion exchanger apparatus 36, membrane deaeration apparatus 37, second pump 38, and first ultrafiltration membrane 39, these components being arranged in the order described above. Ultraviolet-ray oxidization apparatus 34, hydrogen peroxide removal apparatus 35, ion exchanger apparatus 36, membrane deaeration apparatus 37, and first ultrafiltration membrane 39 constitute purifying units of the water to be treated. First pump 33 has an AC motor, and its flow rate is controlled by first inverter 33A. Similarly, second pump 38 has an AC motor, and its flow rate is controlled by second inverter 38A.

Ultraviolet-ray oxidization apparatus 34 radiates ultraviolet rays to the water to be treated in order to decompose organic materials that are contained in the water to be treated. Hydrogen peroxide removal apparatus 35 has catalysts such as palladium (Pd), platinum (Pt), and the like for decomposing hydrogen peroxide that is generated by the radiation of ultraviolet rays. Ion exchanger apparatus 36 that is positioned on the downstream side is thus protected from damage by oxidizing materials. Ion exchanger apparatus 36 has cation exchanger resins and anion exchanger resins that are loaded in a mixed bed and removes ion components in the water to be treated. Membrane deaeration apparatus 37 removes dissolved oxygen and carbon dioxide that are contained in the water to be treated. First ultrafiltration membrane 39 is a purifying unit at the final stage of subsystem 31 and removes fine particles that remain in the water to be treated. First ultrafiltration membrane 39 is connected to and supplies ultrapure water to point of use 51. In FIG. 1, the purifying units other than first ultrafiltration membrane 39 are shown as upstream purifying unit

First particle counter PC1 (first means for measuring fine particles) is provided between membrane deaeration apparatus 37 and first ultrafiltration membrane 39 and measures fine particles (or the number of fine particles for each particle diameter) in the water to be treated at the inlet of first ultrafiltration membrane 39. Second particle counter PC2 (second means for measuring fine particles) is provided between first ultrafiltration membrane 39 and point of use 51 and measures fine particles (or the number of fine particles for each particle diameter) in the water to be treated at the outlet of first ultrafiltration membrane 39. Alternatively, only one of first particle counter PC1 and second particle counter PC2 may be provided, and in that case, second particle counter PC2 is preferably provided. In addition, pressure gauge PI is provided between first ultrafiltration membrane 39 and point of use 51 and measures the pressure at the outlet of first ultrafiltration membrane 39. Pressure gauge PI is provided downstream of second particle counter PC2, but alternatively, may be provided upstream of second particle counter PC2.

Concentrated water that is generated on the primary side of first ultrafiltration membrane 39 (the side on which the water to be treated is supplied) is returned to the upstream side of first ultrafiltration membrane 39 via first concentrated water return line L3. First valve V1 that functions as means for adjusting the flow rate of the concentrated water is provided on first concentrated water return line L3. The point to which the concentrated water is returned is not particularly limited as long as the point is positioned upstream of first ultrafiltration membrane 39. In the present embodiment, the concentrated water is returned to subtank 32. The concentrated water may be returned to primary treated water tank 22 depending on, for example, the water quality of the concentrated water. The concentrated water is treated again by primary pure water system 21, whereby deterioration of the water quality of the ultrapure water that is supplied to point of use 51 can be limited and the water treatment load of subsystem 31 can be mitigated. In this case, however, the treatment capacity of primary pure water system 21 has to be determined based on the sum of the flow rate of the primary treated water that is supplied from pretreatment system 11 and the flow rate of the concentrated water that is returned. This leads to an increase in the treatment capacity of primary pure water system 21, and thereby entails greater design specifications for each apparatus of the primary pure water system (increases in the amount of resins and the number of membranes) and higher water production costs (power consumption, the amount of agent that is consumed, and so on). Returning the concentrated water to subsystem 31 enables the treatment capacity of primary pure water system 21 to be determined based on the flow rate of the primary treated water that is supplied from pretreatment system 11, and thereby enables compact design of each apparatus of the primary pure water system and limits the influence on the water production cost.

The ultrapure water that is not used at point of use 51 is returned to subtank 32 via return line L4 so that the ultrapure water is treated again by subsystem 31 before being supplied to point of use 51. Bypass line L5 is provided that branches from main line L2 between first ultrafiltration membrane 39 and point of use 51. Bypass line L5 merges with return line L4 such that ultrapure water that bypasses point of use 51 is returned to subtank 32 via return line L4 in the present embodiment. Accordingly, bypass line L5 and return line L4 constitute an ultrapure water return line that allows the ultrapure water that passes through first ultrafiltration membrane 39 to bypass point of use 51 and return to the upstream side of first ultrafiltration membrane 39. Second valve V2 is provided on bypass line L5.

The flow rate of the concentrated water that is returned from first ultrafiltration membrane 39 to the upstream side of first ultrafiltration membrane 39, which is subtank 32 in the present embodiment, is typically several percent of the flow rate of the water to be treated that is supplied to first ultrafiltration membrane 39. However, as the flow rate of the concentrated water increases, the flow rate of the ultrapure water that is supplied to point of use 51 decreases. Therefore, it is desirable to limit the flow rate of the concentrated water as much as possible in order to reduce the water production cost. For this purpose, in the present embodiment, when the number of fine particles that is measured by first and second particle counters PC1 and PC2 is within a reasonable level in view of the water quality of ultrapure water, that is, when the number of fine particles is sufficiently lower than the number that is required for point of use 51, the degree of opening of first valve V1, which is the valve for adjusting the flow rate of the concentrated water, is reduced in order to lower the flow rate of the concentrated water. However, when the degree of opening of first valve V1 is adjusted, the pressure in main line L2 varies with repeated increase and decrease. This allows fine particles to easily detach from first ultrafiltration membrane 39 and possibly adversely affect the water quality of the ultrapure water that is supplied to point of use 51.

To cope with this problem, first valve V1 of apparatus for producing ultrapure water 1 (subsystem 31) of the present embodiment can be operated such that when the flow rate of the concentrated water changes, the change in the pressure at the outlet of first ultrafiltration membrane 39 that is measured by pressure gauge PI is kept within a predetermined range. The predetermined range depends on the requirements for point of use 51, but is, for example, within 0.02 MPa and preferably within 0.01 MPa. Alternatively, the predetermined range may be within about 5% and preferably within about 3% of the operation pressure at the inlet of first ultrafiltration membrane 39.

First valve V1 and pressure gauge PI are connected to control section 40, and the operation of first valve V1, specifically, the degree of opening and the opening/closing speed of first valve V1, is controlled by control section 40 based on the pressure at the outlet of first ultrafiltration membrane 39 that is measured by pressure gauge PI. FIG. 3 schematically shows temporal change in the pressure at the outlet of first ultrafiltration membrane 39 (the measurement of pressure gauge PI). For example, when the degree of opening of first valve V1 is changed from a predetermined degree of opening to a different degree of opening at a normal speed (change in degree of opening per time), the pressure at the outlet of first ultrafiltration membrane 39 varies greatly, as shown by the broken line. On the other hand, when the degree of opening is changed at a lower speed, the change in the pressure at the outlet of first ultrafiltration membrane 39 is limited, as shown by the solid line.

Accordingly, fine particles are less likely to detach from first ultrafiltration membrane 39, and increase in the number of fine particles that is measured by second particle counter PC2 is suppressed.

In this process, the output of second pump 38 is preferably controlled by control section 40. The adjustment of the degree of opening of first valve V1 causes both a change in the pressure loss of first ultrafiltration membrane 39 and a variation of the pressure in main line L2, but main line L2 can be kept at a substantially constant pressure by adjusting the discharge rate of the pump. Thus, the change in pressure at the outlet of first ultrafiltration membrane 39 is further limited. In other words, the change in the pressure at the outlet of first ultrafiltration membrane 39 can be more efficiently suppressed by controlling the output of second pump 38 than by only controlling first valve V1. Control section 40 is connected to second inverter 38A of second pump 38, and second inverter 38A is controlled such that the change in pressure at the outlet of first ultrafiltration membrane 39 is kept within the predetermined range. Specifically, when the pressure that is measured by pressure gauge PI increases, control section 40 controls second inverter 38A such that the pump rotation speed decreases, thereby decreasing the pressure at the outlet of first ultrafiltration membrane 39. When the pressure that is measured by pressure gauge PI decreases, control section 40 controls second inverter 38A such that the pump rotation speed increases, thereby increasing the pressure at the outlet of first ultrafiltration membrane 39. First valve V1 and second inverter 38A are controlled in accordance with the change in the pressure that is measured by pressure gauge PI. Accordingly, the operation of first valve V1 and the control of second inverter 38A are preferably automatically controlled by control section 40, although first valve V1 may also be manually operated. It should be noted that the pressure at the outlet of first ultrafiltration membrane 39 can be more precisely controlled by controlling second pump 38 that is positioned immediately upstream of first ultrafiltration membrane 39. Alternatively, first pump 33 (first inverter 33A) may be controlled instead of second pump 38, or both first pump 33 and second pump 38 may be controlled.

There is small time lag between the time when the degree of opening of first valve V1 is changed and the time when the measurement of pressure gauge PI changes due to the change in the degree of opening of first valve V1. Therefore, the degree of opening of first valve V1 is preferably changed little by little and intermittently in order to further ensure that the change in the pressure at the outlet of first ultrafiltration membrane 39 is suppressed. Specifically, the following processes are repeated: processes of slightly changing the degree of opening of first valve V1, adjusting the output of second inverter 38A in accordance with the change in the degree of opening of first valve V1, keeping the degree of opening of first valve V1 at a constant level; waiting until the measurement of pressure gauge PI becomes stable; and thereafter slightly changing the degree of opening of first valve V1 again. In addition, each subsystem 31 has a specific relationship between the pattern of changing the degree of opening of first valve V1, the pattern of changing the output of second pump 38 (the temporal change in the degree of opening or the output), and the measurement of pressure gauge PI. Accordingly, if the relationship is ascertained in advance, a timer control may be used to achieve a pattern of change that can keep the change in pressure at the outlet of first ultrafiltration membrane 39 within the predetermined range.

Descriptions of other embodiments will now be made focusing mainly on differences from the first embodiment. Arrangements that are not described here are the same as in the first embodiment.

### Second Embodiment

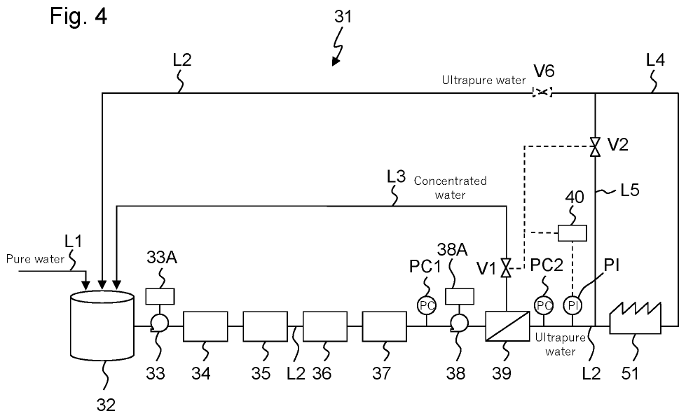

FIG. 4 schematically shows the arrangement of subsystem 31 of the apparatus for producing pure water according to the second embodiment. In the present embodiment, the degree of opening of second valve V2 is controlled instead of second pump 38. First valve V1, second valve V2, and pressure gauge PI are connected to control section 40, and the degrees of opening of first valve V1 and second valve V2 are adjusted based on the measurement of pressure gauge PI. Specifically, when the pressure at the outlet of first ultrafiltration membrane 39 increases, control section 40 increases the degree of opening of second valve V2 (or opens second valve V2), and thereby decreases the pressure at the outlet of first ultrafiltration membrane 39. When the pressure at the outlet of first ultrafiltration membrane 39 decreases, control section 40 decreases the degree of opening of second valve V2 (or closes second valve V2), and thereby increases the pressure at the outlet of first ultrafiltration membrane 39. It is also possible to provide another valve V6 on return line L4 downstream of its merging point with bypass line L5, as shown by broken lines, and to control the degrees of opening of two valves V2 and V6.

Alternatively, it is also possible to control the degree of opening of the outlet valve (not illustrated) of first pump 33 or the outlet valve (not illustrated) of second pump 38.

### Third Embodiment

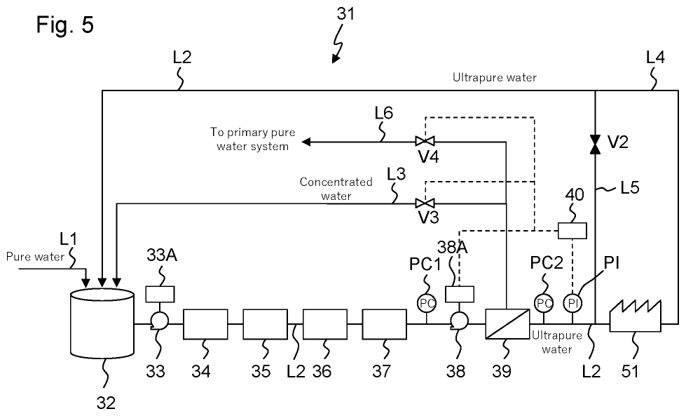

FIG. 5 schematically shows the arrangement of subsystem 31 of the apparatus for producing pure water according to the third embodiment. In the present embodiment, second concentrated water return line L6 is provided that branches from first concentrated water return line L3. Second concentrated water return line L6 returns the concentrated water of first ultrafiltration membrane 39 to the upstream side of the point at which the permeated water of first ultrafiltration membrane 39 is returned. The point to which the concentrated water is returned is not particularly limited, but in the present embodiment, the concentrated water is returned to primary treated water tank 22 of primary pure water system 21. Third valve V3 is provided on first concentrated water return line L3 downstream of the branching point of second concentrated water return line L6, and fourth valve V4 is provided on second concentrated water return line L6. Third valve V3 and fourth valve V4 constitute means for adjusting the flow rate of the concentrated water of the present embodiment.

Third and fourth valves V3 and V4 and first and second particle counters PC1 and PC2 are connected to control section 40. When the numbers of fine particles that are measured by first and second particle counters PC1 and PC2, especially by second particle counter PC2, are smaller than a predetermined permissible value, third valve V3 is fully opened and fourth valve V4 is closed. The arrangement of subsystem 31 in this state is the same as in the first embodiment. When the margin between the numbers of fine particles and the permissible value is small or when the numbers are about the same level as the permissible value, both third valve V3 and fourth valve V4 are opened 50%. Half of the concentrated water is returned to primary treated water tank 22 to be treated by primary pure water system 21, whereby the water quality of the ultrapure water of subsystem 31 is improved. When the numbers of fine particles exceed the permissible value, third valve V3 is closed and fourth valve V4 is fully opened. The entire amount of the concentrated water is returned to primary treated water tank 22 to be treated by primary pure water system 21, whereby the water quality of the ultrapure water of subsystem 31 is improved. The allocation of the flow rates of the concentrated water to first concentrated water return line L3 and second concentrated water return line L6 is not limited to this example and may be determined as appropriate. In other words, in the present embodiment, the means for adjusting the flow rates of the concentrated water (third valve V3 and fourth valve V4) adjusts the flow rate of the concentrated water that flows in second concentrated water return line L6 depending on the fine particles that are detected by the fine particle detection means. Accordingly, when the water quality of the ultrapure water is satisfactory, the flow rate of the ultrapure water that is supplied to point of use 51 is increased, and when the water quality of the ultrapure water deteriorates, the water quality of the ultrapure water can be improved again. It should be noted that the measurements of first and second particle counters PC1 and PC2 may be monitored by an operator and the degrees of opening of third valve V3 and fourth valve V4 may be manually adjusted.

### Fourth Embodiment

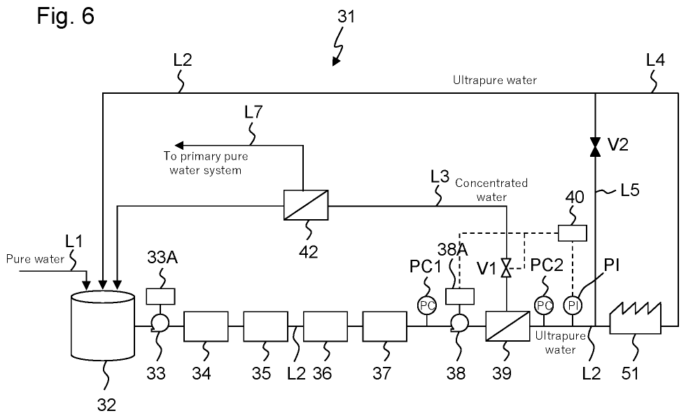

FIG. 6 schematically shows the arrangement of subsystem 31 of the apparatus for producing pure water according to the fourth embodiment. In the present embodiment, second ultrafiltration membrane 42 that filters the concentrated water of first ultrafiltration membrane 39 is provided on first concentrated water return line L3. The permeated water of second ultrafiltration membrane 42 is returned to the upstream side of first ultrafiltration membrane 39, and the concentrated water of second ultrafiltration membrane 42 is returned via third concentrated water return line L7 to the upstream side of the point to which the permeated water is returned. The points to which the permeated water and the concentrated water are returned are not particularly limited, but in the present embodiment, the permeated water is returned to subtank 32, and the concentrated water is returned to primary treated water tank 22 of primary pure water system 21. The water quality of the concentrated water that is returned to subtank 32 is improved by the provision of second ultrafiltration membrane 42, whereby the deterioration of the water quality at the outlet of first ultrafiltration membrane 39 is suppressed.

### Fifth Embodiment

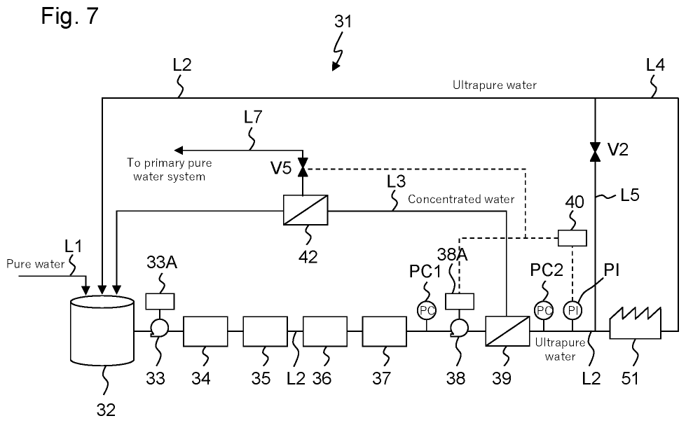

FIG. 7 schematically shows the arrangement of subsystem 31 of the apparatus for producing pure water according to the fifth embodiment. In the present embodiment, first valve V1 of the fourth embodiment is omitted, and fifth valve V5 is provided on third concentrated water return line L7. Accordingly, in the present embodiment, the means for adjusting the flow rate of the concentrated water is fifth valve V5 that is provided on third concentrated water return line L7. The pressure loss of second ultrafiltration membrane 42 is changed by adjusting the degree of opening of fifth valve V5, whereby the flow rate of the concentrated water in first concentrated water return line L3 can be controlled. In the present embodiment, the flow rate of the concentrated water in first concentrated water return line L3 is indirectly controlled, and as a result, changes in the flow rate of the concentrated water that flows in first concentrated water return line L3 are less responsive to changes in the degree of opening of fifth valve V5. This effect is equivalent to the effect obtained by the gentle operation of first valve V1 in the first embodiment. It is also possible to provide first valve V1 but to employ only fifth valve V5 to perform the function of the means for adjusting the flow rate of the concentrated water.

### Sixth Embodiment

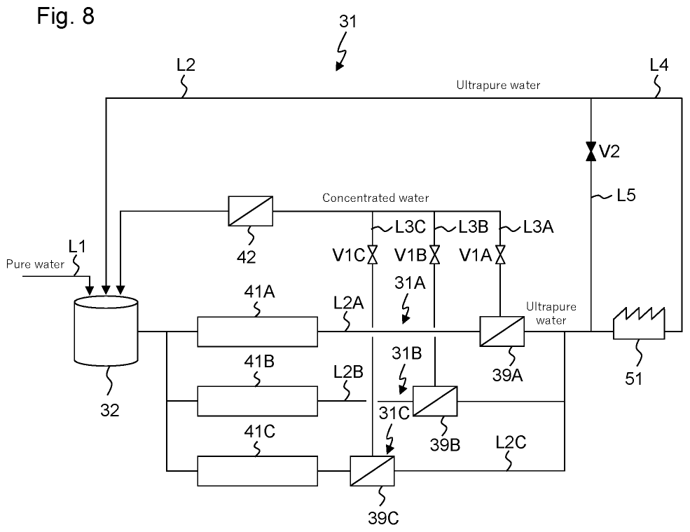

FIG. 8 schematically shows the arrangement of subsystem 31 of the apparatus for producing pure water according to the sixth embodiment. In the present embodiment, a plurality of subsystems 31A, 31B, and 31C are provided in parallel. A plurality of main lines L2A, L2B, and L2C are provided in parallel between subtank 32 and point of use 51. Upstream purifying units 41A, 41B, and 41C and first ultrafiltration membranes 39A, 39B, and 39C of subsystems 31A, 31B, and 31C are arranged along main lines L2A, L2B, and L2C, respectively. In other words, upstream purifying unit 41A and first ultrafiltration membrane 39A of the first embodiment are provided in parallel with other upstream purifying units 41B and 41C and other first ultrafiltration membranes 39B and 39C, and each of first ultrafiltration membranes 39A, 39B, and 39C are connected to and supply ultrapure water to point of use 51. First valves VIA, V1B, and V1C are provided on main lines L2A, L2B, and L2C, respectively, and main lines L2A, L2B, and L2C merge with each other to be connected to second ultrafiltration membrane 42. The concentrated water of first ultrafiltration membranes 39A, 39B, and 39C of subsystems 31A, 31B, and 31C is supplied to second ultrafiltration membrane 42. In other words, second ultrafiltration membrane 42 is shared by the plurality of subsystems 31A, 31 B, and 31C. The flow rate of the concentrated water of first ultrafiltration membranes 39A, 39B, and 39C of subsystems 31A, 31B, and 31C is low, and the cost of apparatus for producing ultrapure water 1 can therefore be reduced by sharing second ultrafiltration membrane 42.

Although certain preferred embodiments of the present invention have been shown and described in detail, it should be understood that various changes and modifications may be made without departing from the spirit or scope of the appended claims.

### LIST OF REFERENCE NUMERALS

1 apparatus for producing ultrapure water
33 first pump
33A first inverter
38 second pump
38A second inverter
39 first ultrafiltration membrane
40 control section
42 second ultrafiltration membrane
51 point of use
L2 main line
L3 first concentrated water return line
L4 return line
L5 bypass line
L6 second concentrated water return line
L7 third concentrated water return line
PC1, PC2 fine particle detection means (first and the second particle counters)
PI pressure gauge

1. An apparatus for producing ultrapure water comprising:
a first ultrafiltration membrane that is connected to a point of use and that supplies ultrapure water to the point of use;
a first concentrated water return line that returns concentrated water of the first ultrafiltration membrane to an upstream side of the first ultrafiltration membrane;
a pressure gauge that measures pressure at an outlet of the first ultrafiltration membrane; and
means for adjusting flow rate of the concentrated water, the means adjusting the flow rate of the concentrated water,
wherein the means for adjusting the flow rate of the concentrated water can be operated such that when the flow rate of the concentrated water is changed, a change in the pressure at the outlet of the first ultrafiltration membrane that is measured by the pressure gauge is kept within a predetermined range.

2. The apparatus for producing ultrapure water according to claim 1, wherein the predetermined range is within 0.02 MPa, or within 5% of an operation pressure at the outlet of the first ultrafiltration membrane.

3. The apparatus for producing ultrapure water according to claim 1, further comprising a control section that controls operation of the means for adjusting the flow rate of the concentrated water such that the change in the pressure at the outlet of the first ultrafiltration membrane is kept within the predetermined range.

4. The apparatus for producing ultrapure water according to claim 3, wherein the means for adjusting the flow rate of the concentrated water is a valve that is provided on the first concentrated water return line, and the control section controls operation of the valve of the means for adjusting the flow rate of the concentrated water.

5. The apparatus for producing ultrapure water according to claim 3, further comprising a pump that is positioned upstream of the first ultrafiltration membrane,
wherein the control section controls the pump based on the pressure at the outlet that is measured by the pressure gauge such that the change in the pressure at the outlet of the first ultrafiltration membrane is kept within the predetermined range.

6. The apparatus for producing ultrapure water according to claim 3, further comprising:
an ultrapure water return line that is connected to the first ultrafiltration membrane and that allows ultrapure water that passes through the first ultrafiltration membrane to bypass the point of use and to return to an upstream side of the first ultrafiltration membrane; and
a valve that is provided on the ultrapure water return line,
wherein the control section controls the valve that is provided on the ultrapure water return line based on the pressure at the outlet that is measured by the pressure gauge such that the change in the pressure at the outlet of the first ultrafiltration membrane is kept within the predetermined range.

7. The apparatus for producing ultrapure water according to claim 1, further comprising:
a second concentrated water return line that branches from the first concentrated water return line and that returns the concentrated water of the first ultrafiltration membrane to an upstream side of a point to which permeated water of the first ultrafiltration membrane is returned; and
fine particle detection means that is provided at least at an inlet or at the outlet the first ultrafiltration membrane,
wherein the means for adjusting the flow rate of the concentrated water adjusts a flow rate of the concentrated water that flows in the second concentrated water return line based on fine particles that are detected by the fine particle detection means.

8. The apparatus for producing ultrapure water according to claim 1, further comprising:
a second ultrafiltration membrane that is provided on the first concentrated water return line, that filters the concentrated water of the first ultrafiltration membrane, and that returns permeated water to an upstream side of the first ultrafiltration membrane; and
a third concentrated water return line that returns concentrated water of the second ultrafiltration membrane to an upstream side of a point to which the permeated water is returned.

9. The apparatus for producing ultrapure water according to claim 8, wherein the means for adjusting the flow rate of the concentrated water is a valve that is provided on the third concentrated water return line.

10. The apparatus for producing ultrapure water according to claim 8, further comprising another first ultrafiltration membrane that is connected to the point of use, that is provided in parallel with the first ultrafiltration membrane, and that supplies ultrapure water to the point of use,
wherein the concentrated water of the first ultrafiltration membrane and concentrated water of the another first ultrafiltration membrane are supplied to the second ultrafiltration membrane.
